(19) United States
(12) Patent Application Publication
(10) Pub. No.: US 2006/0260741 A1
(43) Pub. Date: Nov. 23, 2006

(54) System and method for batch processing of multiple independent print orders

(75) Inventor: Jesse D. Crum, St. Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/166,858

(22) Filed: Jun. 24, 2005

Related U.S. Application Data
(63) Continuation-in-part of application No. 11/135,481, filed on May 23, 2005.
(63) Continuation-in-part of application No. 11/135,179, filed on May 23, 2005.
(63) Continuation-in-part of application No. 11/135,131, filed on May 23, 2005.

(51) Int. Cl. B32B 38/04; B32B 38/14; B32B 37/12; B32B 37/22

(52) U.S. Cl. 156/265; 156/277; 156/250; 156/280; 156/64; 156/302

(57) ABSTRACT

The present invention relates to a system and method for batch or gang running, substantially simultaneously, two or more discrete orders for printed products. The method includes the printing of a sheet of material with each of the discrete print orders, in predetermined areas, with high quality graphics and then separating the sheet into individual segments, with each of the segments containing one of the orders. The segments are then applied in a sequential fashion to a continuously advancing web of material to create an intermittently laminated intermediate web assembly having a series of discrete, pre-printed segments appearing in a substantial edge-to-edge configuration. The segments can then be sorted from one another to differentiate the orders and then supplied to the end user for use in connection with the specific application. The intermediate web assembly can be subjected to further processing steps such as sheeting, application of variable printing, coating and laminating as may be required by the end user application.

### CROSS-REFERENCES TO RELATED APPLICATIONS

This application is a continuation-in-part of application Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference.

### FIELD OF THE INVENTION

The present invention is in the field of systems and methods for batch or gang running multiple print orders at a single time. More particularly, the invention is directed to the production of a number of printed sheets with each sheet having predefined discrete areas relating to specific jobs or applications. The sheets are then cut into individual segments, ribbons or strips, with each strip having a pre-printed area pertaining to a specific job. Through the inclusion of a unique placer mechanism, the segments or ribbons may be placed individually and directly on a web for processing and ease of handling. The web may then be subjected to additional processing steps to segregate the individual jobs for delivery to the end user customer.

The segments or ribbons, which are intended to represent discrete, individual preprinted areas on the sheet, with each area representing a specific order, can be used for a number of printed communication pieces such as labels, tags, cards, etc. The sheets are produced in part, initially from a pre-imaged or pre-printed sheet that is then converted or merged to a roll type of format through use of a placer mechanism.

The sheets are initially printed with high quality graphics or images that relate to the specific order. The sheets are then slit or cut to size to form templates, ribbons, surface elements or segments for the particular applications or jobs being produced. The segments are then converted to or merged with a continuously advancing web to create a continuous intermediate roll format by placing the individual segments on the web in a sequential fashion. The segments that have been affixed to the web are then provided in one or more intermediate configurations to an end user. More particularly, the present invention can be used to create pressure sensitive laminates that can be further manipulated to produce individual, prime labels, tags, cards, etc. that have a high or photo quality resolution level such as those greater than about 150 lines per inch and still preferably greater than about 300 lines per inch or approximately 2500 to 3500 dots per inch.

### BACKGROUND OF THE INVENTION

Printed products, such as pieces that are intended to be used in business communications, can be delivered in a wide variety of formats, constructions and configurations. Normally, one of the most significant limiting factors for a manufacturer being able to produce a particular construction or expand product capabilities is the equipment the manufacturer has on hand to generate such printed pieces.

Traditional manufacturers of business communications, such as business forms and labels, are also usually limited in the type of jobs that a manufacturer will accept based on size of the job, or more particularly the order quantity or value of the order. That is, due to cost factors, a customer will not place an order with a manufacturer for a small to medium sized piece quantity as the set up or make ready of the job makes the order cost prohibitive, even assuming that the manufacturer would accept the order if a particular price could be obtained to justify production.

Such conventional manufacturers have normally produced product runs that range in the hundreds of thousands to millions or even tens of millions of pieces for a single order. As such, the equipment that is used to produce this level or quantity of product is then set up to handle only large manufacturing runs. The apparatus used in this type of fulfillment will normally only operate efficiently in this higher range of production quantities and often cannot be reconfigured. Thus, even if a manufacturer wished to pursue smaller runs or orders sizes, the manufacturer is faced with the dilemma of making new capital expenditures to purchase equipment that specializes in this type of application not to mention having to retrain existing personnel or hire and train new employees to generate this type of production activity.

Another drawback facing conventional manufacturers of business communication products is that in addition to the possibility of retooling the production infrastructure, the producers may also need to seek out new sales channels and distributors for products that fall within the smaller production run niche as the conventional sales channels are likely still focusing on procuring orders for larger production runs.

A still further drawback of trying to migrate to smaller customer applications relates to quality of the pieces that need to be generated. With the focus of the market slowly shifting to smaller runs, the end user is now demanding a greater image quality than that typically associated with conventionally printed products. It is believed that the reason for such far reaching changes is that budgets for marketing and business communications have been cut back in recent years and as such, end users want more from each piece that is produced rather than relying on the quantity of pieces to generate the desired result.

Flexography is one exemplary conventional technology that is commonly used today for the printing of decorative items, because of the ability to print multiple colors. Flexographic technology is commonly used in the rendering of packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time that is involved in preparing a production job to run or “make ready” as it may otherwise be known in the industry. That is, the steps that are used to prepare the flexography equipment for running a particular job or order. This “make ready” process includes such activity as the preparation of multiple plates to produce the image at each station, mixing inks, calibration and alignment of the images between stations and the like.

Operation of the flexographic presses may also include multiple operators which can add to manufacturing costs. In addition, waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready process and waste factors, the production of products (e.g. prime labels) through the use of flexography may then be limited to serving only certain market segments, namely large market segments. Markets that are applicable for this technology segment are generally believed to be those orders for large quantities of hundreds of thousands or millions of pieces, which potentially leaves the smaller label market, e.g. 100 to under a 1,000,000 labels, unfulfilled or at least not adequately served by currently available technologies due to cost and materials thresholds.

Business and marketing communication pieces including identifiers such as labels, business cards or tags may also be readily rendered using desktop equipment. While the resolution may be slightly improved when compared with conventional flexographic technology, speeds of application are significantly reduced as the images are processed in a sheet wise fashion on desktop equipment. This limited production rate results in only a few sheets per minute being produced as opposed to hundreds of feet per minute that are commonly capable of being processed by flexographic equipment. That is, the desktop unit may only handle and print one sheet at a time before the next sheet is advanced for printing or imaging when compared with a conventional web fed process which produces sheets at a faster rate. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed, therefore, is a production method and system by which high quality graphics can be used to create products for a number of distinct, individual printing order or applications for a batch of individual, separate orders in a single continuous process. For example, each order can be produced with graphics that has a resolution in excess of about 150 lines per inch that can be produced in an efficient and cost effective manner, such as in a continuous system operating at greater than fifty feet per minute. Moreover, a system which can add substantial variability to the product as well as other features, such as embossments, over laminates, variable printing or imaging and the like, would greatly expand the penetration of high quality business communication in the marketplace by placing the pieces in the hands of the small to medium sized user.

The present invention seeks to provide an intermediate web assembly that is capable of having a number of different discrete segments, representing a number of individual orders and composed of multiple pieces, e.g. labels, cards, tags, plastics, films and the like created in an efficient and cost effective manner. The segments will typically consist of a series of discrete individual elements with each element or segment having printing or imaging that includes graphical or resolution quality of about 150 or more lines per inch and preferably more than 300 lines per inch, which is approximately equal to about 2500 to 3500 dots per inch (“DPI”) in order to create a high quality imaged product that is intended to be aesthetically appealing to the consumer and to more effectively communicate the business message of the application in the small to medium range market applications.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process or system by which a manufacturer can create high quality printed form product templates, in a continuous process, simultaneously for multiple customers or end users, with each of the templates or ribbons for each order having significantly improved graphic resolution that is greater than about 150 lines per inch, preferably greater than about 200 lines per inch and still more preferably about 300 lines per inch, in an efficient and cost effective manner.

Through the development of the present system and the creation of the unique intermediate web assembly described in this application for this invention, the manufacturer can now simultaneously service a number of individual customers and realize penetration of a particular niche market segment that heretofore may have been largely ignored. The creation of high quality templates in a continuous fashion in quantities such as those ranging from approximately 100 to 1,000,000 can now be effectively and efficiently manufactured through practice of the instant invention. While the foregoing market size or segment is a target area of the present invention, it should be appreciated that the invention may be practiced and used to fulfill larger order quantities, such as those of a million or more.

The pressure sensitive intermediate of the present invention is created through a unique sheet to segment to roll process which provides savings specifically through reduced make ready time and generation of waste material and yields a higher image resolution product when compared with conventional processes such as those produced by using conventional flexographic technologies. In addition, the system and method of the present invention can be utilized to service a number of separate customers in a manner that allows multiple orders to be run at the same time on equipment that has historically been suited to the production of longer runs of business communication documents.

The present invention uses previously prepared (preprinted) individually created sheets, or segments, that have imaging or printing already applied to the sheets, e.g. graphical depictions, before the sheets are cut and the cut portions are provided to the manufacturing press. The printing is provided in pre-defined areas, determined prior to production, to create individual segments that can be used for a number of purposes. The templates or segments are then cut from the sheet and supplied to a feeder mechanism. The templates, sheets, ribbons or segments are then applied to the web in a number of patterns, including substantially edge-to-edge configuration, with a slight overlap or alternatively, provided in regularly occurring increments depending on the needs of the particular application to be serviced.

In addition, the product produced in connection with the present process described in the instant application is also not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between 75-150 feet per minute and still more preferably at speeds of about 200 feet per minute or greater. The intermediate web assembly of the present invention can then be used to produce orders for multiple customers at the same time without having to reconfigure equipment or purchase new machinery in order to produce product in a cost effective and yet profitable manner.

In one exemplary embodiment, a method of batch running print orders is presented and includes the steps of initially obtaining a number of print orders for independent items, with each of the print order having requirements for text, graphics or combinations thereof. The orders may be obtained through marketing efforts, advertising or the solicitation of business through direct and indirect contact with end users, distributors or resellers. Each of the print orders that is being solicited will generally be in the small to medium size or quantity range and will be such that the orders can be run economically by batching or grouping the orders together, despite each order having different requirements.

Next, information relating to each of the orders is collected, such as by written responses to quotations, telephone inquiries, electronic messages, facsimile transmissions and other means common in the printing industry for receiving and collecting details relating to production of a particular printing order.

Once the information concerning the individual orders has been received then each of the orders is formatted to create distinct printing instructions for each of the orders. That is, the graphics are “cleaned up” so that the image will appear crisp, the textual portions are checked for errors and the printing area and size of the product is determined for positioning. Once the foregoing steps have been completed, then placement of each order on at least one sheet is determined so as to maximize the arrangement on the sheet. After the layout has been finalized, the sheet is printed with at least one of each of the orders that has been previously configured.

The sheets, after printing, are then cut into discrete segments, with each segment containing at least one order. Each of the segments are then placed into a feeder mechanism that will be used to individually place the segments on a web.

The web, which has a coating of pressure sensitive adhesive applied to one face thereof, is advanced past the feeder mechanism and then the segments are deposited, sequentially onto the web over the pattern of adhesive to create a laminated web assembly that has a series of individual segments that are disposed in a substantially edge-to-edge relationship.

In a further exemplary embodiment of the present invention, a method for gang running discrete orders, is described and includes the steps of initially receiving requests for multiple discrete print orders from at least one location with each order having graphical depictions of a relatively high quality. A sheet of printable stock material is selected that is suitable for producing simultaneously at least two of the orders with a sufficient quality of resolution. Then the sheet is printed with at least two of the discrete print orders. After printing, the sheet is separated into at least first and second ribbons with each ribbon containing a different one of the discrete print orders. Finally, the first and second ribbons are placed sequentially on a continuously advancing web of material in a substantial edge-to-edge configuration.

In a yet still further embodiment of the present invention, a method for producing separate print orders in a substantially simultaneous fashion, is described and includes the steps of initially advertising the availability of small to medium range high quality business communication piece production capabilities to select market niches. Advertising may occur through any number of means, including the production of marketing collateral that is distributed through audio and visual communication mediums, over a global communication network, through printed mediums including newspapers, trade publications, magazines, fliers, handouts and combinations thereof.

Next, the hoped for result of an advertising campaign is the generation of quotations for printed products in connection with a request for pricing information based on the advertising. Once at least two discrete production orders are collected, a layout arrangement is determined for each of the production orders on a sheet of printable stock material. Then each production order is printed on the sheet of stock material in pre-defined areas representing discrete segments on the sheet. The sheet is then cut, such as by die cutting or laser die cutting to separate the individual segments from the sheet.

Once the segments are free of the sheet, the segments are placed in a placer mechanism that will position each of the segments on a continuous web that is being advanced in a machine direction. The resulting web of material provides an intermediate web assembly that has a substantial edge-to-edge configuration of intermittently laminated high quality segments.

The segments that are created in each of the foregoing embodiments can be sorted at any time, either prior to being placed in the feeder or placer mechanism or after the segments have been deposited on the web of material. By sorting, the individual print orders can be assembled for delivery to an end user.

Other embodiments related to the previously described methods, include verification steps, wherein placement of each of the segments once the web is confirmed, separating the web into individual laminated sheets of material, with each sheet having at least one segment or ribbon mounted thereto, and providing different shaped segments onto the web assembly, such as geometric, animate and inanimate shaped objects.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a block diagram of an exemplary method used in carrying out the present invention;

FIG. 2 shows a web of material having a number of individual segments provided thereon and prepared using an exemplary method in accordance with the present invention;

FIG. 3 provides a further web of material with a number of arranged segments provided thereon and prepared using an exemplary method in accordance with the present invention;

FIG. 4 shows a cross sectional view of the web of material with a number of arranged segments provided thereon and prepared using an exemplary method in accordance with the present invention;

FIG. 5 illustrates a further exemplary method of practicing the present invention described herein; and

FIG. 6 depicts a yet still further exemplary method of practicing the present invention described herein.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

As used herein an “order” or a “production order” refers to an order for a single product type, selected for example from a group including labels, prime labels, cards, tags, magnetic products, laminated products, printed pieces and the like. Where two or more orders are produced in a single production run, the orders may come from a single entity or from multiple discrete entities, that is, one customer or multiple customers.

For example, a restaurant may order prime labels for placement on “take-out” food containers and coupons or gift checks for in store promotions. Each item, the label and coupon, in this example, represents an order for a particular product, although each of the products originates from the same customer or end user and will be likely paid through a single invoice.

Likewise, two distinct end users or distributors may each place an order for a prime label product, for each of their respective uses, and each prime label will have distinct indicia or graphics for the label application. Thus, there are two distinct orders, each for a prime label, two invoices and two customers. In each of these examples, the products or orders can be generated in the same production run as opposed to conventional processes, such as flexography, where the orders must be run separately from each other. Thus, by using the current process and system, a number of small to medium sized orders can be produced, which heretofore may not have been possible due to quantity restrictions.

It should be understood, that the invention is not limited to two types of orders or products, and instead it should be realized that multiple orders, including a multiplicity of products from a variety of end users can be produced simultaneously using the method and system of the present invention.

The term “batch” or “gang” refers to the grouping, collecting or assimilating individual print orders or printed products together, regardless of the type, configuration, use or application, for a single production run as may be accomplished in connection with the present invention.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein the term “business communication” is used to refer to a printed or imaged piece, document or substrate that, either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate or document which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment for example, could be subject to die cutting or additional printing, such as through ink jetting, over laminating, coating or embossment, and then applied to a container, carton, consumer package good or the like.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25″ sheet may be produced with five rows of labels, with each row having six labels, with each label having dimensions of approximately 3″×4″. For instance, in this example, each row may comprise an individual segment or sheet that may be used in practicing the present invention. It should however be understood that the invention is not to be so limited to the foregoing configuration and that individual pieces or elements, regardless whether the piece or elements have a regular or irregular shape, may be used in connection with this process to produce the intermediate assembly that is described in this application.

As used herein, the term “templates”, “segment”, “ribbon” or “element” refers to a particular size, configuration or arrangement of a piece. For example, if the template or segment is a label, the label may have a size of 2×4, 1×2 and other sizes that may be customarily produced. Likewise, if the piece is a card, the card may have a size ranging from 3×5, 2×4 or any other suitably sized card. The term templates can be used to refer to segments, ribbons and similar terms.

Through use of the present invention, a vast array of identifiers, e.g. printed pieces, labels, tags, cards, plates, magnets, laminates, etc. can be placed on an adhesive coated web and then collected for later use, thereby creating a versatile pressure sensitive intermediate web assembly. Through the use of the foregoing process a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional applicators.

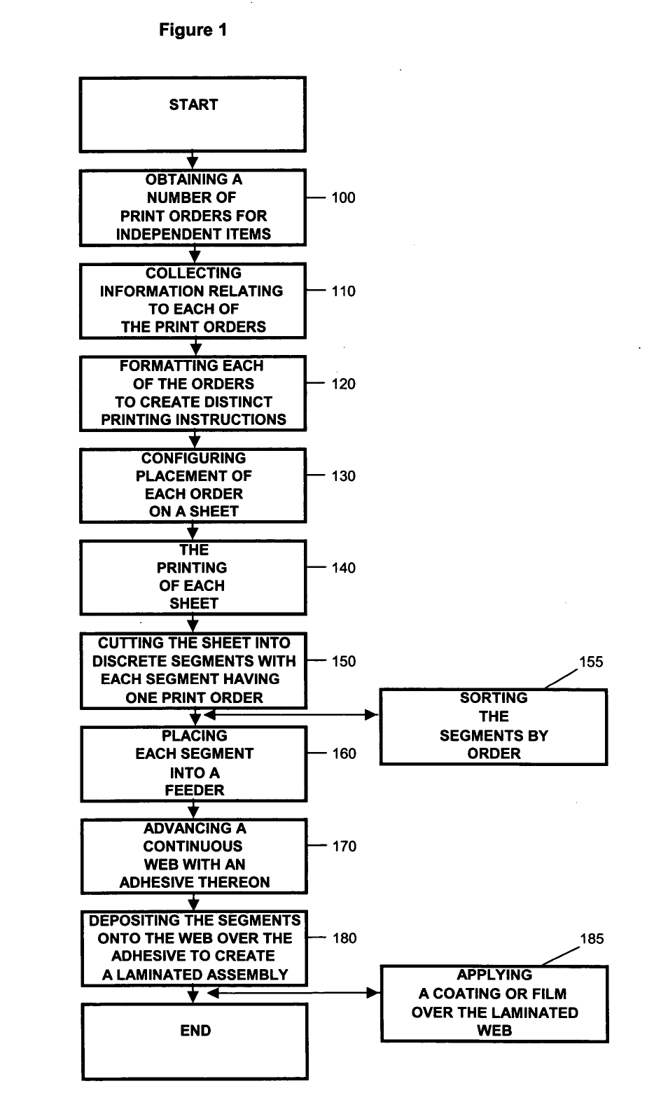

Reference is now directed to FIG. 1 of the present invention which provides a block diagram relating to an exemplary method of batch running print orders. The method includes initially obtaining a number of print orders for independent items at step 100, with each of the print order having requirements for text, graphics or combinations thereof. Typically, the graphics that are sought for production will be high quality graphics having a resolution of at least about 150 lines per inch, preferably greater than 200 lines per inch and still more preferably about 300 lines per inch.

The print orders may be obtained through marketing efforts, advertising or the solicitation of business through direct and indirect contact. Each of the print orders that is being solicited will generally be in the small to medium size or quantity range and will be such that the orders can be run economically by batching or grouping the orders together, despite each order having different requirements.

Next, information relating to each of the orders is collected at step 110, such as by written responses to quotations, telephone inquiries, electronic messages, facsimile transmissions and other means common in the printing industry for receiving and collecting details relating to production of a particular printing order.

Once the information concerning the individual orders has been received then each of the orders is formatted to create distinct printing instructions for each of the orders at step 120. That is, the graphics are “cleaned up”, such as by using “pre-flight” software programs, so that the image will appear crisp, the textual portions are checked for errors and the printing area and size of the product is determined for positioning. Once the foregoing steps have been completed, then placement of each order on at least one sheet is determined so as to maximize the arrangement on the sheet at step 130. After the layout has been finalized, the sheet is printed at step 140 with at least one of each of the orders that has been previously configured.

Examples of image generating or high quality printing devices that are suitable for use in practicing the invention include high resolution imaging devices such as Indigo®, available from Hewlett Packard of Palo Alto, Calilf. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

The sheets, after printing, are then cut into discrete segments at step 150, with each segment containing at least one order. Cutting of the sheet may be accomplished by die cutting, laser die cutting, guillotine or other suitable means known in the industry. Each of the segments is then placed into a feeder mechanism at step 160 that will be used to individually place the segments on a web. An exemplary feeder or placer mechanism is available from Maverick® available from In-Line Automation of Minneapolis, Minn. The exemplary unit may use a vacuum cylinder to take the segments from the hopper and then deposit the individual segments sequentially on the surface of the web over an adhesive in a machine direction. It should be understood, that the invention is not limited by the type of placer mechanism used in the present example.

The web, which has a coating of pressure sensitive adhesive applied to one face thereof, is advanced at step 170 past the feeder mechanism and then the segments are individually deposited at step 180, in a sequential fashion onto the web over the pattern of adhesive to create a laminated web assembly that has a series of individual segments that are disposed in a substantially edge-to-edge relationship.

The foregoing process may also undergo additional steps such as sorting of the segments at step 155 by individual job order. That is, when the segments are cut from the sheet at step 150, all of the segments relating to a specific job are collected and then placed into the hopper or feeder mechanism. In this manner, the segments relating to a job can all be placed together on a section of the web so that, the respective section(s) may then be cut and delivered to the end user. Alternatively, the sorting may occur after the segments have been placed onto the web and the individual segments are then collected when the web in its intermediate laminated form is cut or severed.

An additional processing step may include the placing of a protective film, coating or other supplemental or additional item over the top of the segments at step 185.

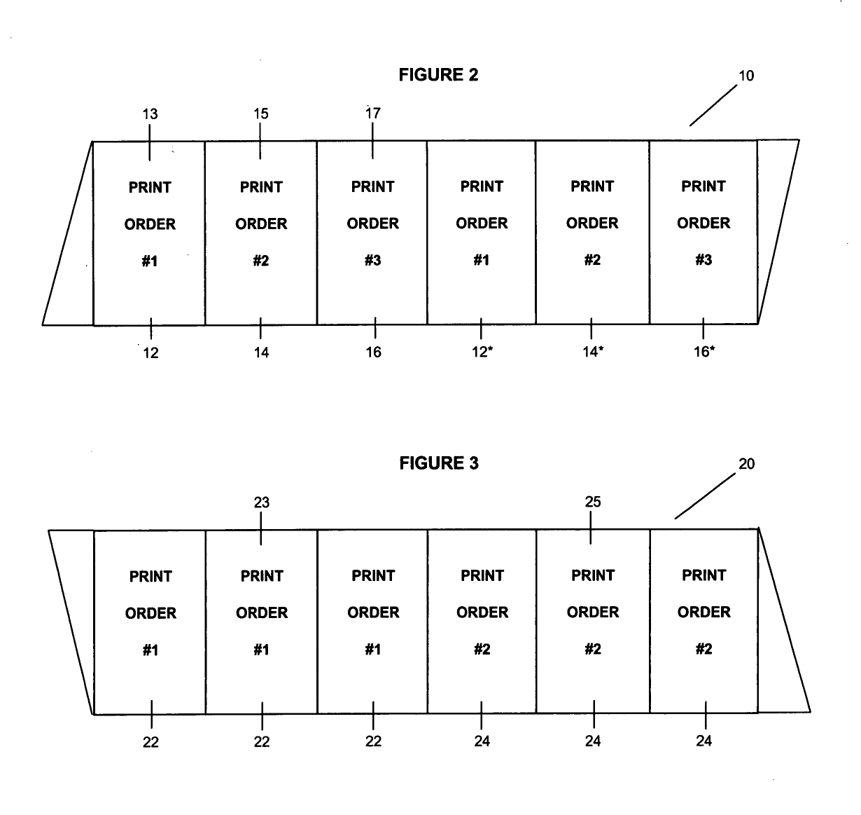

Attention is now directed to FIGS. 2 and 3 of the present invention in which two different web configurations have been produced. In FIG. 2 the web 10 has been created having three discrete printing orders, represented by segments 12, 14 and 16 which then repeat as segments 12*, 14* and 16*. Each of segments 12, 14 and 16 and the repeating sequence of segments, is imprinted with information relating to the particular job, here simply represented by indicia 13, 15 and 17 respectively, indicating “print order #1”, “print order #2” and “print order #3.” Obviously, any printing or graphical indicia can be applied to the segments, and the simplistic indicia presented in the drawings are presented for example only.

In assembling the intermediate web of FIG. 2, the segments 12, 14 and 16 and repeating segments would be collected after production of the web, by cutting the web into individual sheets or simply separating the discrete segments. In the former, the sheets would have to be further cut to separate the segments, but the sheets may be more readily handled in the press environment and as such, the manufacturer may not elect to separate the individual segments from the web at the press location.

FIG. 3 shows an alternate intermediate web configuration generally depicted by reference to numeral 20. In this arrangement, the segments of one order 22, containing a first printed order 23, would be collected or sorted after the pre-printed sheet is produced and then the segments placed into the hopper for the feeder or placer mechanism so that the segments 22 are disposed on the web in an adjacent configuration to one another. A second set of segments 24 containing a second printed job 25, is similarly sorted after cutting of the pre-printed sheet, the segments 24 are then collected and placed into the feeder for disposition on the web. In this fashion, the web may easily be sheeted into groups, with each group containing a particular printing order. The sheets would then be severed to separate the individual segments from one another.

It should be understood that the components of the printing orders may themselves vary. For example, printing order #1 may be prime labels and printing order #2 may be tags. There is no limit to the variability capable with the process described in the present invention.

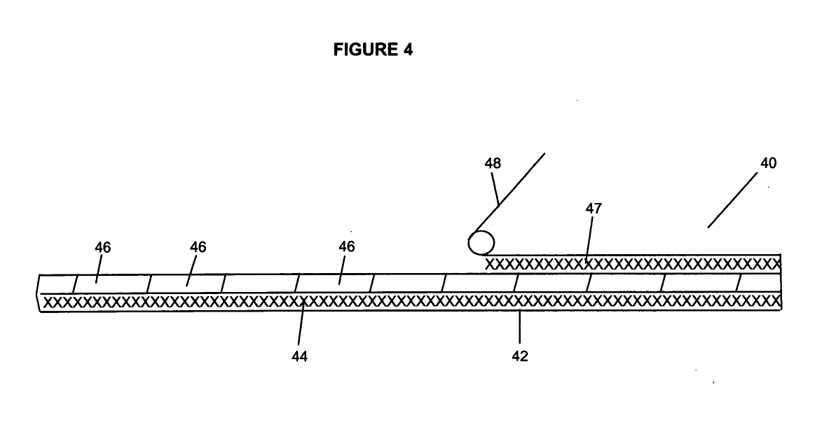

FIG. 4 is presented to show a cross sectional arrangement of the intermediate web assembly of the present invention. The web is generally referred to by numeral 40 and includes a continuous web of material 42. The web of material is preferably cellulosic based and is coated with a pattern of adhesive 44. A release layer (not shown) may be provided on the surface of the web 42 which would allow the adhesive to release to the back of the segments when the segments are removed from the web. Alternatively, the adhesive may only be used to create a frangible bond that temporarily holds the segments to the web during processing and as such, no release layer may be necessary. Preferably, a permanent adhesive will be used when producing pressure sensitive laminate assemblies, however, it should be understood that removable or repositionable adhesives may also be used as well as combinations of the foregoing.

A series of segments, represented generally by numeral designation 46 are applied sequentially and individually to the web 42 over the adhesive 44. FIG. 4 also shows the application of a layer of film 48 being applied over the surface of the segments. Application of a film will typically require an adhesive layer 47 to bond the film to the surface of the segments.

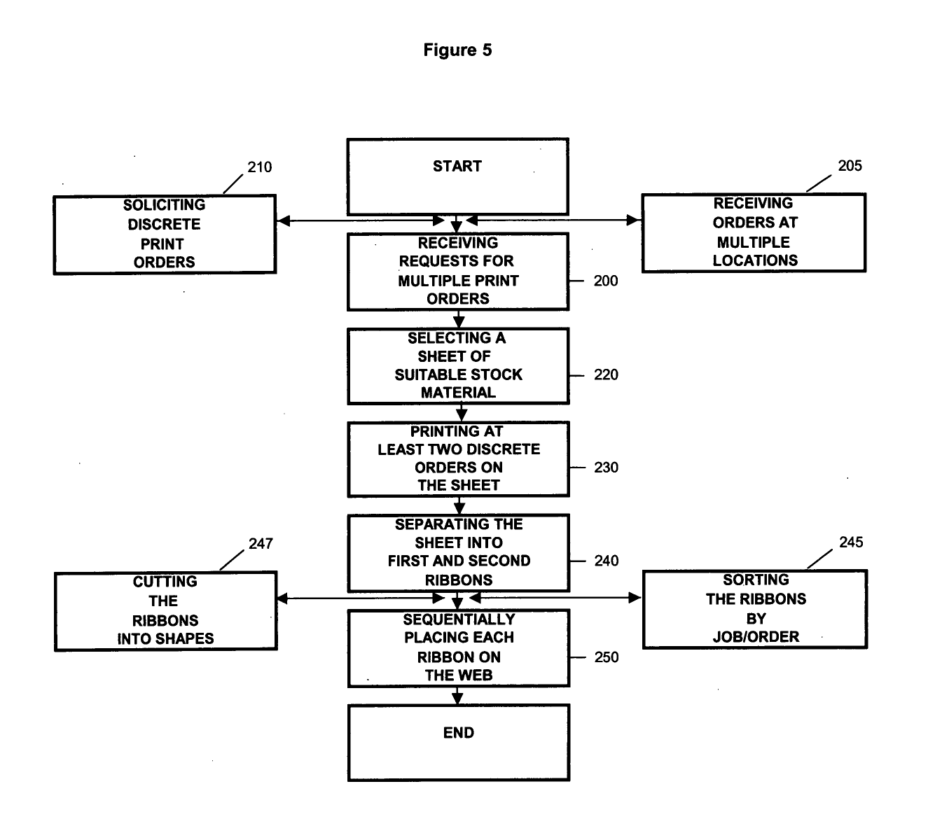

Attention is now directed to FIG. 5, which provides a further exemplary block diagram illustrating a method of practicing the present invention. A method for gang running discrete orders is described and includes initially receiving requests for multiple discrete print orders from at least one location at step 200 with each order having graphical depictions of a relatively high quality. The location may be a sales office, manufacturing location or simply a computer terminal connected to a global communications network. The method can also be practiced by collecting orders at a second location 205 and additional locations may be added or utilized as may be necessary. An additional step, 210, may include the soliciting of discrete print orders from customers of printed products, or from distributors or resellers of printed products.

A sheet of printable stock material is selected at step 220 and should be one that is suitable for producing simultaneously at least two of the orders with a sufficient quality of resolution. Then the sheet is printed with at least two of the discrete print orders at step 230.

After printing, the sheet is separated at step 240 into at least first and second ribbons by cutting, preferably die cutting, with each ribbon containing a different one of the discrete print orders. The ribbons may be cut into regularly occurring shapes or may be cut into different and uniquely shaped segments at step 247. The different or discrete printing orders are represented by the web and segment laminate assemblies of FIGS. 2 and 3 described above. Finally, the first and second ribbons are placed sequentially on a continuously advancing web of material in a substantial edge-to-edge configuration at step 250.

In order to facilitate fulfillment of a particular order, the ribbons can be sorted at step 245 as has been previously described herein. The sorting may occur prior to placing of the ribbons in the feeder mechanism or subsequent to formation of the web.

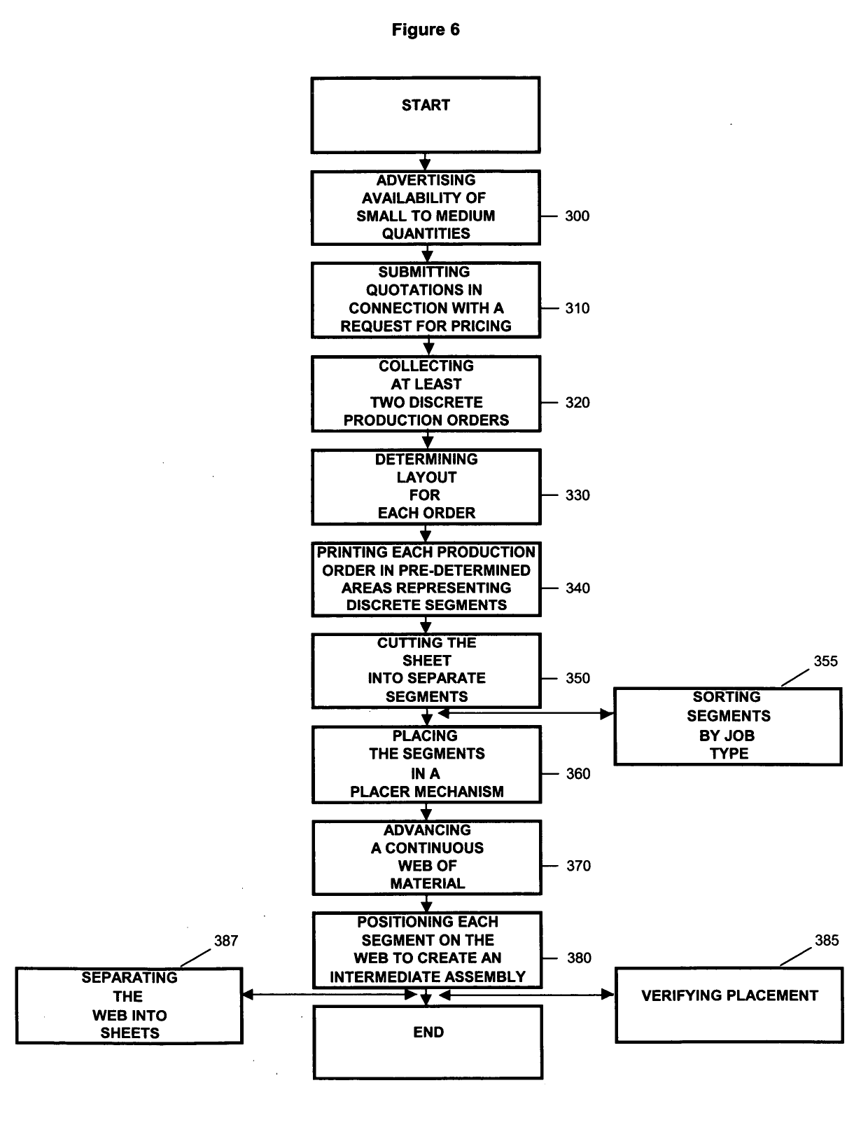

Reference is now directed to FIG. 6 of the present invention which illustrates a further exemplary block diagram showing a process of practicing the invention described herein. The method relates to producing separate print orders in a substantially simultaneous fashion. Initially, at step 300 the manufacturer or service provider advertises the availability of small to medium range high quality business communication piece production capabilities to select market niches. Advertising may occur through any number of means, including the production of marketing collateral that is distributed through audio and visual communication mediums, over a global communication network, through printed mediums including newspapers, trade publications, magazines, fliers, handouts and combinations thereof. The market niches may include healthcare, financial, promotional and advertisement agencies, public service sectors, retail and wholesale markets and other commercial segments that may require printed communications of a relatively high quality.

Next, the hoped for result of an advertising campaign is the generation of quotations for printed products at step 310 in connection with a request for pricing information based on the advertising. Typically, the quotation will include the time, materials and other consumables as well as any special requests, such as expedited service.

Once at least two discrete production orders are collected at step 320, a layout arrangement is determined for each of the production orders at step 330 on a sheet of printable stock material. Then each production order is printed on the sheet of stock material in pre-defined areas representing discrete segments on the sheet at step 340 as has been previously described above. The sheet is then cut at step 350, such as by die cutting or laser die cutting to separate the individual segments from the sheet.

Once the segments are free of the sheet, the segments are placed in a placer mechanism at step 360 that will position each of the segments on a continuous web that is being advanced in a machine direction at step 370. The resulting web of material provides an intermediate web assembly that has a substantial edge-to-edge configuration of intermittently laminated high quality segments at step 380.

The segments that are created in each of the foregoing embodiments can be sorted at any time, such as at step 355, and the sorting can occur either prior to the segments being placed in the feeder or placer mechanism or after the segments have been deposited on the web of material. By sorting, the individual print orders can be assembled for delivery to an end user. If the step of sorting is to be performed after the intermediate web assembly has been created, then the web is cut into individual sheets at step 387.

The method of the presently described embodiment may also include a step of verifying placement of the ribbons or segments on the web at step 385. By conducting a step of verification, the process will ensure proper placement and alignment of the segments on the web and detect any errors that may require a system shutdown.

One of the most important things with respect to new product innovations is the need to effectively market and communicate the new product to potential customers and end users of the product. Such marketing typically includes the creation of marketing collateral associated with the features of the present method and system and its benefits and uses. These unique products produced by the system and in accordance with the method of the present invention are sold in connection with that marketing collateral and then distributing the end product to potential end users and customers or transferring the technology to others for incorporation in their respective products. Customers can include distributors of such products as well as office supply stores, retail and warehouse outlets, manufacturers of such products which themselves may not be end users, but may repackage and resell the products to end users or third parties.

Marketing collateral for communicating business or marketing messages as used herein includes the use of scripted or prepared material that are distributed through audio and visual communication mediums, over a global communication network, through printed mediums such as newspapers, trade publications, magazines, fliers, handouts and the like.

The present invention further fulfills the need of the small to medium range market for magnetic pieces, those quantities typically between 100 and 1,000,000 without requiring the payment of substantial premiums as may be necessary to offset the costs associated with traditional processes such as flexographic technology.

It will thus be seen according to the present invention a highly advantageous system and method for producing separate orders in a simultaneous fashion has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method of batch running print orders, comprising the steps of;
obtaining a number of print orders for independent items, each print order having requirements for text, graphics or combinations thereof;
collecting information relating to each of said orders;
formatting each of said orders to create distinct printing instructions for each of said orders;
configuring placement of each order on at least one sheet;
printing said sheet with at least one of each of said orders;
cutting said sheet into discrete segments, with each segment containing at least one order;
placing each of said segments into a feeder;
advancing a web having a coating of pressure sensitive adhesive applied to one face thereof; and
depositing, sequentially each of said segments onto said web over said pattern of adhesive to create a laminated web assembly having a series of individual segments disposed in a substantially edge-to-edge relationship.

2. A method as recited in claim 1, wherein a series of sheets are printed with each of said orders and including a further step of assembling each order from each of said sheets into a stack prior to the step of placing.

3. A method as recited in claim 1, including a further step of cutting said laminated web into individual sheets, with each sheet containing at least one segment after the step of depositing sequentially each of said segments onto said web.

4. A method as recited in claim 1, including a further step of applying a coating or film over said laminated web assembly after the step of depositing sequentially each of said segments onto said web.

5. A method as recited in claim 1, wherein said method is used to produce simultaneously said discrete print orders.

6. A method as recited in claim 1, including a further step of verifying placement of each of said segments on said web after the step of depositing sequentially each of said segments onto said web.

7. A method as recited in claim 1, including a further step of sorting said print orders at any time after the step of printing said sheet.

8. A method for gang running discrete orders, comprising the steps of;
receiving requests for multiple discrete print orders in at least one location, each order having graphical depictions of a relatively high quality;
selecting a sheet of printable stock material suitable for producing simultaneously at least two of said orders;
printing at least two of said discrete print orders on a surface of said sheet;
separating said sheet into at least first and second ribbons with each ribbon containing a different one of said discrete print orders; and
placing sequentially said first and second ribbons on a continuously advancing web of material in a substantial edge-to-edge configuration.

9. A method as recited in claim 8, wherein said method includes receiving print orders in at least two locations, remote from one another.

10. A method as recited in claim 8, including a further step of sorting said discrete print orders at any time prior to placing sequentially said first and second ribbons on a continuously advancing web of material.

11. A method as recited in claim 8, wherein said step of separating is performed to create shaped ribbons that are selected from a group including geometric, animate, inanimate and combinations thereof.

12. A method as recited in claim 8, including a further step of soliciting print orders from select market segments prior to the step of receiving requests for multiple discrete print orders.

13. A method as recited in claim 8, including a further step of configuring each of said discrete print orders on said sheet prior to the step of printing said sheet with each of said discrete print orders.

14. A method for producing separate print orders in a substantially simultaneous fashion, comprising the steps of;
advertising availability of small to medium range high quality business communication piece production capabilities to select market niches;
submitting quotations in connection with a request for pricing information based on said advertising;
collecting at least two discrete production orders;
determining layout arrangement of each production order on a sheet of printable stock material;
printing each production order on said sheet of stock material in pre-defined areas representing discrete segments on said sheet;
cutting said sheet to separate said segments;
placing said segments in a placer mechanism;
advancing a continuous web of material in a machine direction; and
positioning each of said segments on said web of material in said machine direction to create an intermediate web assembly having a substantial edge-to-edge configuration of intermittently laminated high quality segments.

15. A method as recited in claim 14, including a further step of sorting said segments of each of said production orders prior to the step of placing said segments in a placer mechanism.

16. A method as recited in claim 14, including a further step of separating said intermediate web assembly into individual laminated sheets after the step of positioning each of said segments on said web.

17. A method as recited in claim 16, including a further step of sorting said segments of each of said production orders after the step of separating said intermediate web assembly.

18. A method as recited in claim 16, wherein the step of advertising includes preparing marketing collateral that is distributed through audio and visual communication mediums, over a global communication network, through printed mediums including newspapers, trade publications, magazines, fliers, handouts and combinations thereof.

19. A method as recited in claim 16, including a further step of verifying placement of each segment prior to the step of positioning each of said segments on said web of material.

20. A method as recited in claim 16, including a further step of receiving at least two discrete production orders after the step of submitting quotations in connection with a request for pricing information.
